(19) United States
(12) Patent Application Publication
(10) Pub. No.: US 2004/0193394 A1
(43) Pub. Date: Sep. 30, 2004

(54) Method for CPU simulation using virtual machine extensions

(76) Inventors: Konstantin Levit-Gurevich, Kiryat Byalik (IL); Igor Liokumovich, Netanya (IL); Ido Shamir, Kfar-Monash (IL)

Correspondence Address: BLAKELY, SOKOLOFF, TAYLOR & ZAFMAN LLP, 12400 Wilshire Boulevard, Seventh Floor, Los Angeles, CA, 90025-1026, US

(21) Appl. No.: 10/395,557

(22) Filed: Mar. 24, 2003

(51) Int. Cl. G06F 9/45; G06F 9/455

(52) U.S. Cl. 703/22; 718/1

(57) ABSTRACT

According to one embodiment, a computer system is disclosed. The computer system comprises a central processing unit (CPU) to generate and control a virtual machine that runs simulated instruction code and create an abstraction of a real machine so that operation of a real operating system for the computer system is not impeded.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to Central Processing Unit (CPU) simulators; more particularly, the present invention relates to employing direct execution of simulated code on a CPU.

### BACKGROUND

Software simulators for CPUs (e.g., Gambit, Archsim, etc) have a wide range of usage in many areas relating to integrated circuit design, validation and tuning. These simulators are commonly used for pre-silicon software development (e.g., BIOS, operating systems, compilers, applications, etc.) for architecture validation (functional and performance), and more. A user may evaluate an instruction set architecture (ISA) of a new CPU by executing benchmarks on a host machine that runs the simulator.

Based on the results produced by the simulator, a user may modify or verify the new CPU design accordingly. Moreover, the simulator can be expanded to simulate the behavior of an entire PC platform, including buses and I/O devices (for example, SoftSDV platform simulator). A possible input for such a simulator may be an operating system called a “Simulated” or “Guest” OS.

The permanent increase in both scale and complexity of the simulated code (operating systems and applications) requires improvement of current simulation techniques and introduction of new technologies in order to achieve significant simulation speedup. If the simulated CPU and the host CPU architectures are close (or identical) the simulated instructions can be allowed to run natively. However, most operating systems for personal computers assume full control over the machine resources. Thus, if the simulated operating system is allowed to run natively it will conflict with the host operating system over PC resources (CPU, devices, memory, etc.).

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates a high level architecture of one embodiment of a simulation environment; and

FIG. 3 is a flow diagram of one embodiment of the operation of Full Platform Simulator.

### DETAILED DESCRIPTION

A method of using hardware support for virtualization in order to prevent conflicts between a Host operating system (OS) and a Guest OS, and to obtain a full virtualization is described. In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

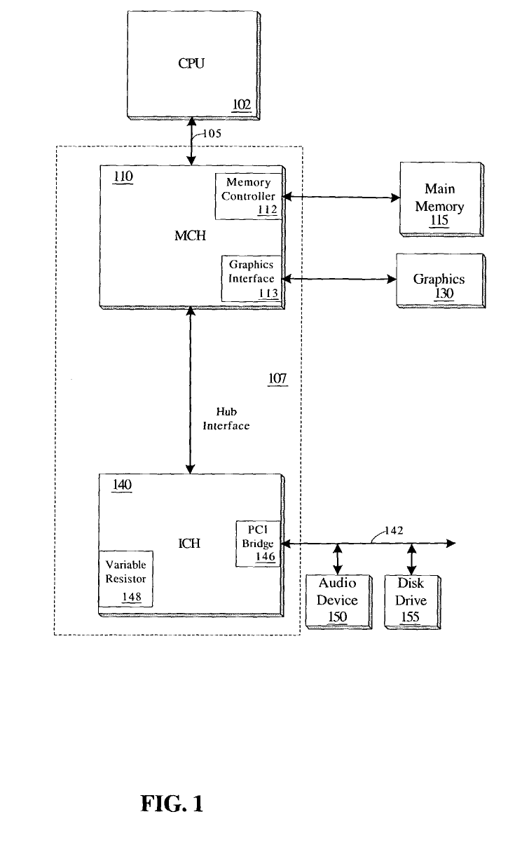

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to bus 105, such as multiple CPUs and/or multiple system memories.

MCH 110 may also include a graphics interface 113 coupled to a graphics accelerator 130. In one embodiment, graphics interface 113 is coupled to graphics accelerator 130 via an accelerated graphics port (AGP) that operates according to an AGP Specification Revision 2.0 interface developed by Intel Corporation of Santa Clara, Calif.

In addition, the hub interface couples MCH 110 to an input/output control hub (ICH) 140 via a hub interface. ICH 140 provides an interface to input/output (I/O) devices within computer system 100. ICH 140 may be coupled to a Peripheral Component Interconnect bus adhering to a Specification Revision 2.1 bus developed by the PCI Special Interest Group of Portland, Oreg. Thus, ICH 140 includes a PCI bridge 146 that provides an interface to a PCI bus 142. PCI bridge 146 provides a data path between CPU 102 and peripheral devices.

PCI bus 142 includes an audio device 150 and a disk drive 155. However, one of ordinary skill in the art will appreciate that other devices may be coupled to PCI bus 142. In addition, one of ordinary skill in the art will recognize that CPU 102 and MCH 110 could be combined to form a single chip. Further graphics accelerator 130 may be included within MCH 110 in other embodiments.

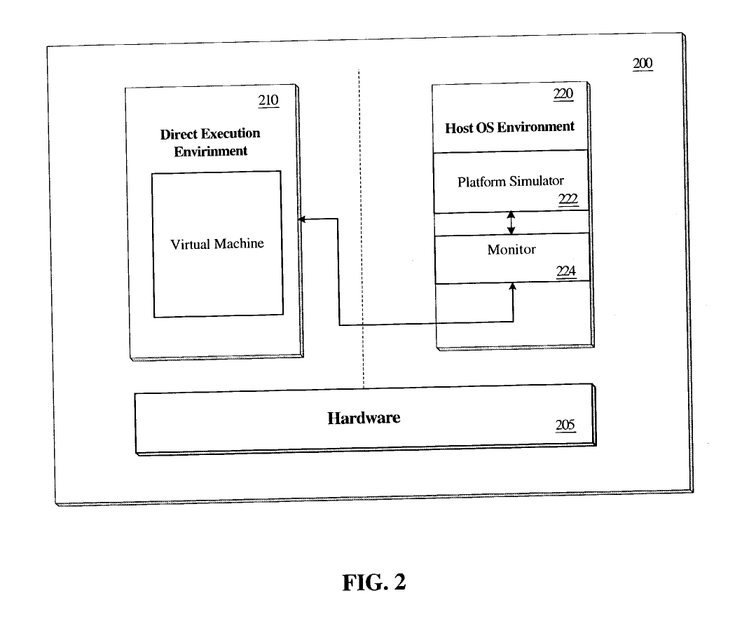

FIG. 2 illustrates one embodiment of architecture 200 for a simulation environment. The architecture 200 includes hardware 205 that runs the simulation environment. According to one embodiment, hardware 205 supports Lagrande Technology. Lagrande Technology (LT) is a technology that allows support for virtual machines on IA-32 processors. Support is given for two principal classes of software: monitor (or host) and guest. Monitor Software (or, more simply, “the monitor”) should have full control of CPU 102 when it is running. The monitor presents guest software with a processor abstraction and allows it to execute on CPU 102. However, the monitor should be able to retain control of the processor resources, physical memory, interrupt management, and I/O.

According to one embodiment, CPU 102 support for virtualization is provided with a new form of processor operation, called Virtual Machine Extension (VMX) operation. A new set of instructions is enabled in VMX operation. In addition, two kinds of control transfers, called VM entries and VM exits, are enabled. These transitions are managed by a new structure called a virtual-machine control structure (or VMCS).

All guest software runs in VMX operation. The VMCS controlling execution of VMX operation may cause certain events, operations, and situations that cause VM exits. A VM exit causes the processor to transfer control to a monitor entry point determined by controlling the VMCS. The monitor thus gains control of the processor on a VM exit and can take action appropriate to the event, operation, or situation that caused the VM exit. It can then return to the context managed by the VMCS via a VM entry.

If the VM monitor properly constructs the VMCS, it can prevent guest software from determining that it is running in VMX operation. The VMCS has been designed to include facilities that would allow VM monitor to virtualize CPU 102.

Referring back to FIG. 2, the simulation environment includes a Direct Execution Environment 210, and a Host OS environment 220. Direct Execution Environment 210 includes Guest code (OS and/or applications) running in a virtual machine. When launching (or resuming) virtual machine hardware 205 performs a full context switch from the context of a Host OS to that of the Guest OS, and allows the Guest code to run natively (at an original privilege level and at the original virtual addresses) on CPU 102. CPU 102 performs common architectural checks. While running in the Virtual Machine CPU 102 performs additional checks to discover virtualization events (described below).

Host OS environment 220 includes Full Platform Simulator 222 and Monitor 224. In one embodiment, Full Platform Simulator 222 runs in a user privilege level. Monitor 224 has parts running at the system privilege and parts running in the user privilege level. Monitor 224 controls the execution of the Guest code and represents a bridge between Direct Execution Environment 210 and Host OS environment 220. Monitor 224 creates and resumes a Virtual Machine (VM) by using hardware 205 support.

In addition, Monitor 224 regains control back from the Virtual Machine when the code running in Virtual Machine tries to perform a sensitive action. These sensitive actions, which are not permitted to be performed in the VM, are called “Virtualization Events”. In one embodiment, Monitor 224 configures the CPU, at which Virtualization Events should be checked while running in Virtual Machine, as well as which state components should be loaded/restored upon resuming the VM.

According to one embodiment, Virtualization Events include hardware interrupts, attempts to change virtual address space (Page Tables), access to devices (e.g., I/O instructions), control register access, Page Faults handling, etc. Monitor 224 performs the required state synchronization and handles a Virtualization Event.

Monitor 224 analyzes the reason caused to exit from the Virtual Machine and performs an appropriate Virtualization operation. In one embodiment, Monitor 224 handles the Virtualization Event and resumes Direct Execution Environment back. Alternatively, Monitor 224 passes control to Full Platform Simulator 222 for simulation of the faulting instruction.

In a further embodiment, Monitor 224 performs virtualization operations in such a manner that prevents the Guest OS from compromising Host OS integrity. For example, Monitor 224 manages Page Tables used in the Virtual Machine, and maps the Guest virtual addresses to the physical addresses allocated from host memory, rather than physical addresses intended by guest OS.

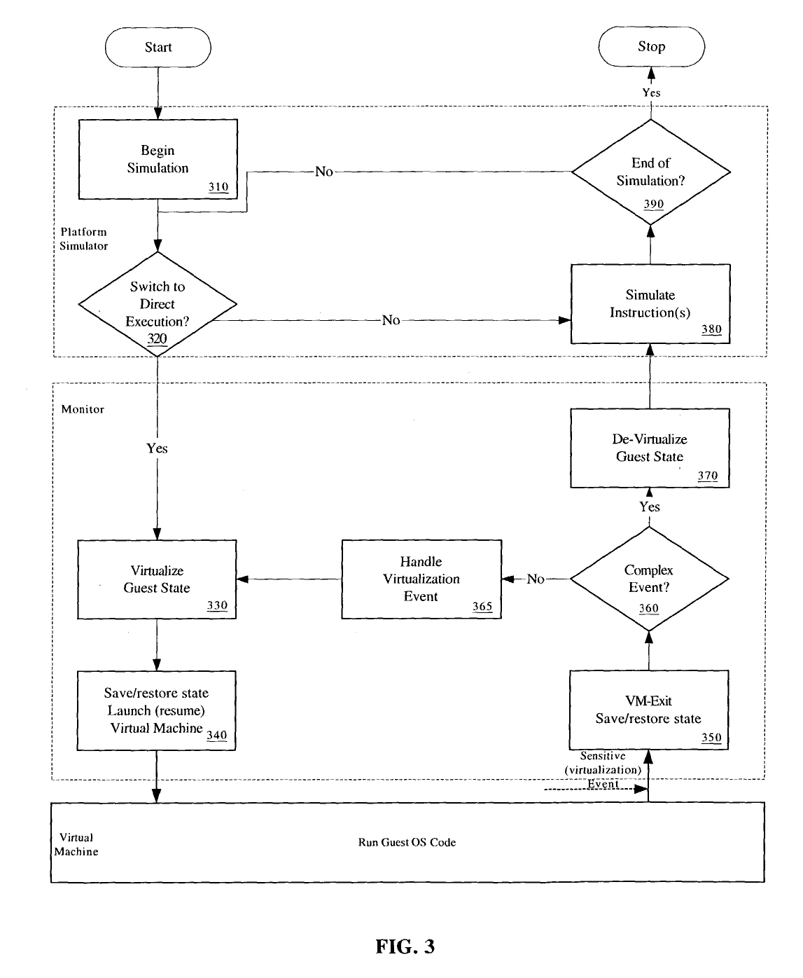

Platform Simulator 222 runs as a regular process on top of the Host OS. FIG. 3 is a flow diagram of one embodiment of the operation of Full Platform Simulator 222. At processing block 310, simulation begins. At decision block 320, Platform Simulator 222 determines whether to switch to Direct Execution.

If Platform Simulator 222 decides to switch to Direct Execution, Monitor 224 is invoked with request to launch (or resume) Direct Execution and a guest state is virtualized, processing block 330. Otherwise, simulation continues at Platform Simulator 222, processing block 380. At processing block 340, the Virtual Machine is launched (or resumed). Subsequently, the Virtual Machine begins to run guest OS code.

At some time during the running of the guest OS code, a sensitive (or virtualization) event occurs. Therefore, at processing block 350, the Virtual Machine is exited and the current state is saved/restored. At decision block 360, it is determined whether the sensitive event is a complex event. If the event is not a complex event, the event is a virtualization event, and the virtualization event is managed at processing block 365. Subsequently, control is returned to processing block 330 where the guest state is virtualized.

If the event is a complex event, the guest state is de-virtualized, processing block 370. At processing block 380, instructions are again simulated. At decision block 390, it is determined whether the simulation has ended. If not, control is returned to processing block 310 where simulation continues. Otherwise, the simulation is stopped.

The above description describes a Virtual Machine architecture that enables support for the creation, maintenance and control of a Virtual Machine that can run Guest (simulated) code while creating a full abstraction of a real machine. Thus, Virtual Machine Extensions are used for the easy detection of sensitive CPU events, resulting in the ability to switch between a Virtual Machine that runs Guest (or simulated) code and a Virtual Machine monitor that is a component of the host software.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A computer system comprising:
a central processing unit (CPU) to generate and control a virtual machine that runs simulated instruction code and to create an abstraction of a real machine so that operation of a real operating system for the computer system is not impeded.

2. The computer system of claim 1 wherein the CPU runs the simulated instruction code and the real operating system.

3. The computer system of claim 1 further comprising:
a direct execution environment to store simulated instruction code and associated data; and
a host operating system environment.

4. The computer system of claim 3 wherein the host operating system environment comprises:
a monitor to generate the virtual machine using the hardware; and
a platform simulator to perform simulations of virtualization events;

5. The computer system of claim 4 wherein the monitor performs virtualization operations.

6. The computer system of claim 5 wherein the monitor gains control from the virtual machine whenever the virtual machine attempts to perform a virtualization event.

7. The computer system of claim 6 wherein the monitor sets a list of virtualization events to be checked by the virtual machine.

8. The computer system of claim 7 wherein the monitor passes control to the monitor for the handling of the virtualization event.

9. The computer system of claim 8 wherein the monitor performs a particular virtualization operation upon determining the type of virtualization event.

10. The computer system of claim 9 wherein the monitor handles the virtualization event and returns execution to the monitor.

11. The computer system of claim 9 wherein the monitor passes control to the platform simulator for simulation of the virtualization event.

12. The computer system of claim 8 wherein the monitor virtualization operations in such a manner to prevent the simulated instruction code from affecting the real operating system.

13. A method comprising: simulating instruction code at a central processing unit (CPU) implementing Virtual Machine Extensions (VMX);
virtualizing simulated instruction code;
launching a virtual machine(VM) at the CPU; and
executing simulated instruction code on the VM.

14. The method of claim 13 further comprising:
detecting a sensitive event;
exiting the VM; and
analyzing the sensitive event.

15. The method of claim 14 further comprising:
determining whether the sensitive event is a complex event; and
virtualizing the simulated instruction code if the sensitive event is not a complex event.

16. The method of claim 15 further comprising resuming the VM after the simulated instruction code is virtualized.

17. The method of claim 15 further comprising:
de-virtualizing the simulated instruction code if the sensitive event is a complex event; and
simulating the instruction code.

18. A system comprising:
hardware to generate and control a virtual machine that runs simulated instruction code and to create an abstraction of a real machine so that operation of a real operating system for the computer system is not impeded;
a direct execution environment to store simulated instruction code and associated data; and
a host operating system environment.

19. The system of claim 18 wherein the host operating system environment comprises:
a monitor to generate the virtual machine using the hardware; and
a platform simulator to perform simulations of virtualization events;

20. The system of claim 19 wherein the monitor performs virtualization operations.

21. The system of claim 20 wherein the monitor gains control from the virtual machine whenever the virtual machine attempts to perform a virtualization event.

22. The computer system of claim 21 wherein the monitor sets a list of virtualization events to be checked by the virtual machine.

23. The system of claim 22 wherein the monitor performs a particular virtualization operation upon determining the type of virtualization event.

24. The system of claim 23 wherein the monitor handles the virtualization event and resumes Direct Execution Environment back.

25. The computer system of claim 24 wherein the monitor passes control to the platform simulator for simulation of the virtualization event.

26. The computer system of claim 23 wherein the monitor virtualizes operations in such a manner to prevent the simulated instruction code from affecting the real operating system.
